(19) United States
(12) Patent Application Publication
(10) Pub. No.: US 2002/0101509 A1
(43) Pub. Date: Aug. 1, 2002

(54) Crashworthy audio/ video recording system for use in a locomotive

(76) Inventor: Randall Joseph Slomski, Wattsburg, PA (US)

Correspondence Address: David A. Fox, Esq., Cantor Colburn LLP, 55 Griffin Road South, Bloomfield, CT, 06002, US

(21) Appl. No.: 09/770,815

(22) Filed: Jan. 26, 2001

Related U.S. Application Data
(60) Provisional application No. 60/235,976, filed on Sep. 28, 2000.

(51) Int. Cl. H04N 7/18

(52) U.S. Cl. 348/143; 348/148; 340/500

(57) ABSTRACT

An exemplary embodiment of the invention is a locomotive event recording system with an enhanced, crashworthy memory module. This system includes an event recorder for capturing locomotive parameters. A recording system is coupled to the event recorder and the enhanced memory module and provides digital audio and video data for storage.

### CROSS-REFERENCE TO RELATED APPLICATIONS

This application claims the benefit of U.S. provisional patent application 60/235,976 filed Sep. 28, 2000, the entire contents of which are incorporated herein by reference.

### BACKGROUND OF THE INVENTION

The invention relates to event recording systems and in particular, to a crashworthy audio/video event recorder for use in a locomotive. Crashworthy event recorders exist for use with locomotives. Such event recorders receive data corresponding to numerous parameters such as speed, acceleration, etc., from the locomotive control system over a communications channel (e.g., RS 422 interface). Upon the occurrence of an event the event recorder stores locomotive data in a crash survivable memory module. Due to the type of data being recorded, the storage capacity of these memory modules is typically required to be no larger than about 2 megabytes in size. An exemplary crash survivable locomotive event recorder is produced by Electrodynamics, Inc.

Locomotive audio/video recording systems are also known in the art. An exemplary locomotive audio/video recording system is the RailView™ system available from Transportation Technology Group. In such audio/video recording systems, video data and optionally audio data are stored to a high capacity, non-crashworthy memory device such as a floppy disk drive, hard disk drive or magnetic tape. Upon the occurrence of an event such as a crash, the recorded audio data and video data could be lost due to physical damage to the non-crashworthy memory device. Thus, there is a high probability of the device failing to record data at the time of most critical need.

### SUMMARY OF THE INVENTION

An exemplary embodiment of the invention is a comprehensive, crashworthy locomotive event recording system. The system incorporates an event recorder for capturing locomotive operating data and an audio/video recording system that provides digital audio and video data for recording. A crashworthy memory module with increased storage capacity is coupled to the event recorder and the audio/video recording system and securely stores both the locomotive data and the digital audio/video data.

### BRIEF DESCRIPTION OF THE DRAWINGS

FIG. 1 is a block diagram of an exemplary crashworthy audio/video recording system.

FIG. 2 is a block diagram depicting an exemplary memory module.

### DETAILED DESCRIPTION OF THE INVENTION

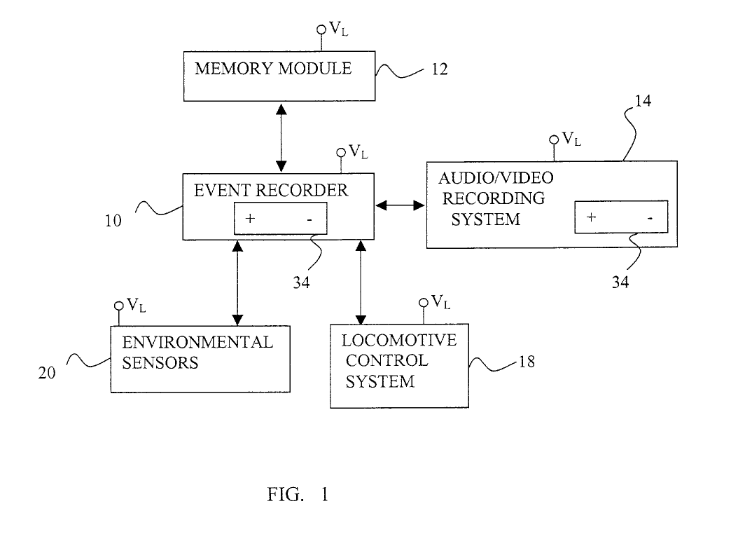

FIG. 1 is a block diagram of an exemplary crashworthy audio/video recording system. The system includes an event recorder 10 which, for example, may be similar to existing locomotive event recorders. The system includes a memory module 12 that is a crash survivable. Conventional memory modules limit the memory size to typically less than 2 megabytes storage capacity. The memory module 12 provides at least 1 gigabyte of memory in a preferred embodiment. In one embodiment, the memory module 12 uses flash memory. Memory module 12 may also include non-volatile random access memory (RAM).

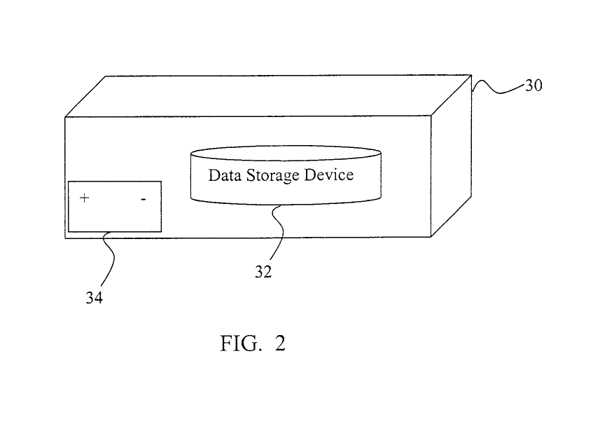

As shown in FIG. 2, the memory module 12 includes a housing 30 that protects a data storage device 32 against mechanical and electrical damage during an event (e.g. a crash of the locomotive) so as to preserve data held in data storage device 32. The data storage device 32 is preferably a solid-state, non-volatile memory of sufficient storage capacity to provide long-term data storage of the locomotive data, environmental data, video data and audio data for a significant period of time (e.g., 15 minutes) associated with an event.

The event recorder 10 receives locomotive data from the locomotive control system 18 such as acceleration, speed, direction, braking conditions, etc. The event recorder 10 may continually store locomotive data in the memory module 12 on a first-in, first-out basis. This allows the system to capture locomotive data leading up to an event. Alternatively, the event recorder 10 can initiate storing locomotive data in the memory module 12 upon detection of an event. Detection of an event is performed using known techniques (e.g., accelerometers, etc.).

Coupled to the event recorder 10 and the enhanced memory module 12 is an audio/video recording system 14. The audio/video recording system 14 generates digital audio data and digital video data that is either stored directly in the memory module 12 or stored in coordination with data provided by the event recorder 10. Typically, the audio/video recording system 14 includes a camera that is directed out the front of the locomotive, and optionally a microphone to record audio such as the application of the locomotive horn. The camera may be directed to the side of the locomotive or multiple cameras may be used to capture images from multiple areas. This preserves a record of items on or near the track in the event of a crash. The video data and audio data (if used) may be stored continuously in the memory module 12 in a first-in, first-out basis. Again, this allows the event recorder 10 to store a predetermined amount of video/audio data leading up to an event. Alternatively, the event recorder 10 can initiate storing video/audio data in the memory module 12 upon detection of an event. The amount of video data stored is limited by the storage capacity of memory module 12.

The system of FIG. 1 allows information from the video recording system 14 to be stored in a crashworthy memory module 12. Upon occurrence of an event, the audio/video data is preserved in memory module 12. This enhances the ability to determine the cause of an event. The capacity of the memory module 12 can be increased as required to store additional audio/video data or locomotive data.

The system shown in FIG. 1 provides for integrated capture of locomotive data (e.g., speed, acceleration, etc.), video data and audio data in a single crashworthy memory module. By sharing a common crashworthy memory module 12, the functionality of the individual devices is enhanced. Additionally, other devices that record data or events pertaining to the locomotive can be coupled to the crashworthy memory module 12. Data from environmental sensors 20 such as track geometry monitors, smoke and fire detectors, chemical or fuel detectors and others may be simultaneously stored in this enhanced crashworthy memory module. This also enhances the ability to determine the cause of an event.

By collecting locomotive data, video data, audio data and environmental data in a single, crashworthy memory module, the system of FIG. 1 provides for enhanced analysis of locomotive events. Conventional systems fail to store video data in a crashworthy memory and thus hinder analysis of locomotive events if such video is not recoverable. The addition of environmental data stored on the same crashworthy memory module further enhances the ability to investigate locomotive events.

The event recorder 10, memory module 12, audio/video recording system 14, locomotive control system 18 and environmental sensors 20 may be powered during normal operation from a locomotive power supply V_{L}. The source of locomotive power supply V_{L} may be a generator driven by the locomotives engine. The event recorder 10, memory module 12, audio/video recording system 14 may include auxiliary power supplies such as batteries 34. During failure or disruption of the locomotive power supply V_{L}, auxiliary power supplies 34 are utilized. Alternatively, instead of separate auxiliary power supplies for each component, an auxiliary power supply could supplement locomotive power supply V_{L} in the event of a failure or disruption locomotive power supply V_{L}.

It will be understood that a person skilled in the art may make modifications to the preferred embodiment shown herein within the scope and intent of the claims. While the present invention has been described as carried out in a specific embodiment thereof, it is not intended to be limited thereby but is intended to cover the invention broadly within the scope and spirit of the claims.

What is claimed is:

1. An event recorder system for a locomotive for monitoring and recording a plurality of parameters relating to an event, the recorder system comprising:
a camera mounted for gathering video data regarding the environment adjacent the locomotive at the time of the event;
a plurality of sensors for gathering further data regarding other parameters associated with the operation of the locomotive at the time of the event;
a crashworthy memory module comprising a housing and an electronic data storage device in the housing;
the housing protecting the data storage device against mechanical and electrical damage during an event so as to preserve contents of said data storage device; and
the data storage device being a solid-state, non-volatile memory of sufficient storage capacity to provide long-term data storage of said further data and said video data for a significant period of time associated with an event.

2. The event recorder system of claim 1 wherein one said sensors is a microphone and said further data includes audio data related to the event.

3. The event recorder system of claim 1 wherein said further data includes locomotive data from a locomotive control system controlling the operation of the locomotive.

4. The event recorder system of claim 1 wherein one said sensors is an environmental sensor and said further data includes environmental data related to the event.

5. The event recorder of claim 4 wherein said environmental sensor is a track geometry monitor.

6. The event recorder of claim 4 wherein said environmental sensor is a smoke detector.

7. The event recorder of claim 4 wherein said environmental sensor is a fire detector.

8. The event recorder of claim 4 wherein said environmental sensor is a chemical detector.

9. The event recorder of claim 4 wherein said environmental sensor is a fuel detector.

10. The event recorder system of claim 1 wherein the memory is a flash memory.

11. The event recorder system of claim 1 wherein the memory capacity is at least 1 gigabit.

12. The event recorder system of claim 1 wherein the locomotive includes a power supply providing power to the memory module during normal operation of the locomotive and further comprises an auxiliary power supply for the memory module to provide power if the vehicle power supply becomes inoperative during a locomotive event.

13. The event recorder system of claim 1 wherein the vehicle includes a power supply providing power to the video camera during normal operation of the vehicle and further comprises an auxiliary power supply for the video camera to provide power if the vehicle power supply becomes inoperative during a locomotive event.

14. The event recorder system of claim 1 wherein said camera is directed to an area in front of the locomotive to capture images in such area.

15. The event recorder system of claim 1 wherein said camera is directed to an area at the side of the locomotive to capture images in such area.
